(19) United States
(12) Patent Application Publication
(10) Pub. No.: US 2010/0264160 A1
(43) Pub. Date: Oct. 21, 2010

(54) Multi-Stream Draught Beer Dispensing System

(75) Inventors: Scott K. Simmonds, Loveland, CO (US); Michael D. Calvelage, Loveland, CO (US)

Correspondence Address: PATENT, COPYRIGHT & TRADEMARK LAW GROUP, 4199 Kinross Lakes Parkway, Suite 275, RICHFIELD, OH, 44286, US

(73) Assignee: 3HABRO, LLC;

(21) Appl. No.: 12/495,162

(22) Filed: Jun. 30, 2009

Related U.S. Application Data
(63) Continuation-in-part of application No. 12/176,547, filed on Jul. 21, 2008.

(51) Int. Cl. B67D 5/60; B67D 7/06

(52) U.S. Cl. 222/1; 222/132; 222/144.5

(57) ABSTRACT

A multiple draught beer dispensing system comprises one tap handle, one spigot, at least three fluid streams, and at least three pressurized tanks corresponding with the fluid streams. A plurality of individual electronic poppet control valves are used to control multiple fluid streams. When the tap handle selects a draft, the poppet valve is actuated by the tap dispenser handle to the beer stream selected so that beer can travel out of the spigot.

### RELATED APPLICATIONS

The present application is a Continuation in Part of U.S. Ser. No. 12/176,547 filed on Jul. 21, 2008, and incorporated by reference herein as if rewritten in its entirety.

### BACKGROUND OF THE INVENTION

1. Field of the Invention

The present invention relates to beer taps and, more specifically, to a tap that allows multiple streams of draught beers to be dispersed from one keg handle.

2. Background of the Invention

Competition is fierce for draft beer in liquor venues because of the limited space for keg fonts. In many cases, large distributors, such as, for example, Anheuser-Busch, Miller, and Coors, are oligopolies in the marketplace for keg fonts. Hence, sales of lesser known bottled micro-brews are lost to the better known and less-expensive draught beers. A need has been long felt to introduce a system that provides greater selection of draft beers utilizing the same keg font space.

A search of the prior art reveals references that teach single valve that controls multiple fluid streams: U.S. Pat. No. 5,653,269 to Miller et al. teaches a “method and apparatus for multiple-channel dispensing of natural gas”, wherein the dispensing system supports multiple dispensing hoses from a single supply plenum; and, U.S. Pat. No. 5,979,713 to Grill teaches a “tap assembly adapted for a fluid dispenser”, wherein a tap is adapted for a fluid mixture dispenser having a source of a first fluid and multiple sources of a second, pressurized fluid.

The present method of dispensing includes a valve plate which is rotated and pulled to align an internal tube with selected fluid streams while it simultaneously seals others. U.S. Pat. No. 5,706,871 to Andersson et al. teaches a “fluid control apparatus and method” in which one valve assembly controls the flow of fluid from multiple sources. More specifically, a single pump serves a plurality of gasoline dispensing nozzles. A member rotates relative to a fixed valve unit with the arrangement being such that the rotation controls the flow of fluid through the assembly. The member is rotated to the position corresponding to the unit actuated.

U.S. Pat. No. 6,053,475 to Batschied et al. teaches a “tap for withdrawing fluid from a container, wherein the tapping process is effected by a rotary motion. An inner tube is guided in an outer tube to slide in an axial direction which can be rotated to let beer be tapped.

The following examples are samples of recently patented taps having novel features: U.S. Pat. No. 6,698,629 to Taylor-McCune teaches a “comestible fluid dispensing tap and method” having a draw-back valve that draws fluid upstream when it is closed; and, U.S. Pat. No. 6,736,159 to Becker teaches a “beverage tap” having a special steel inner part securely pressed with a snug fit. A tubular, steel part of a spout is placed to its side in a liquid-tight matter. A fixture for a ball joint for the shutoff valve is held snuggly to fit to a side by means of a swivel nut.

Consequently, the present invention allows multiple streams of draught beers to be dispensed from one faucet.

### SUMMARY OF THE INVENTION

It is an object of the present invention to provide a tap that allows for multiple streams of draught beers to be dispersed from one tap handle.

It is an object that the present invention provides an opportunity to increase draught dispensing by 300%; namely, it is an object that lesser-known micro-brews are able to expand to draught markets that have often excluded them because of a limit to keg font space.

It is an object that the present individual keg fonts not take up additional space at a bar front; rather, multiple fluid stream lines associated with a single tap handle travel to separate, and individual inconspicuous pressurized containers.

It is therefore an object to maximize a selection of draft beer to patrons and thence a same in business opportunities to owners.

The present invention includes a single tap dispenser handle that associates with a plurality of individual electronic poppet control valves to control multiple fluid streams. The dispenser utilizes a plurality of solenoid actuated or manually actuated poppet valves, each of which which seals off a selected fluid stream. In a first embodiment, when the tap handle selects a draft, the poppet valve is actuated by the tap dispenser handle to the beer stream selected so that beer can travel out of the spigot. In a second embodiment, the tap handle merely actuates one of a plurality of solenoids that subsequently actuate the appropriate poppet valve in a similar fashion.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front elevational view of a multi stream draught beer tap according to a preferred embodiment of the present invention utilizing a solenoid valve actuating system;

FIG. 2 is a side elevational view thereof;

FIG. 3 is a front exploded perspective view thereof;

FIG. 4 is a partial rear exploded view thereof; and

FIG. 5 is a side elevational view of the view shown in FIG. 4;

FIG. 6 is a side elevational view of a tap nozzle for use with a multi-stream draught bear tap of the present invention;

FIG. 7 is a top detailed photograph of a valve manifold 18 for use therewith;

FIG. 8 is an exploded side elevational view of a draught beer tap according to an alternate preferred embodiment of the present invention utilizing a mechanically actuated poppet valve system;

FIG. 9 is a top plan view thereof;

FIG. 10 is an electrical control schematic according to a preferred embodiment; and

FIG. 11 is an electrical control schematic according to an alternate embodiment thereof.

### DESCRIPTION OF THE PREFERRED EMBODIMENTS

The best mode for carrying out the invention is presented in terms of its preferred embodiment, herein depicted within the Figures:

### 1. Detailed Description of the Figures

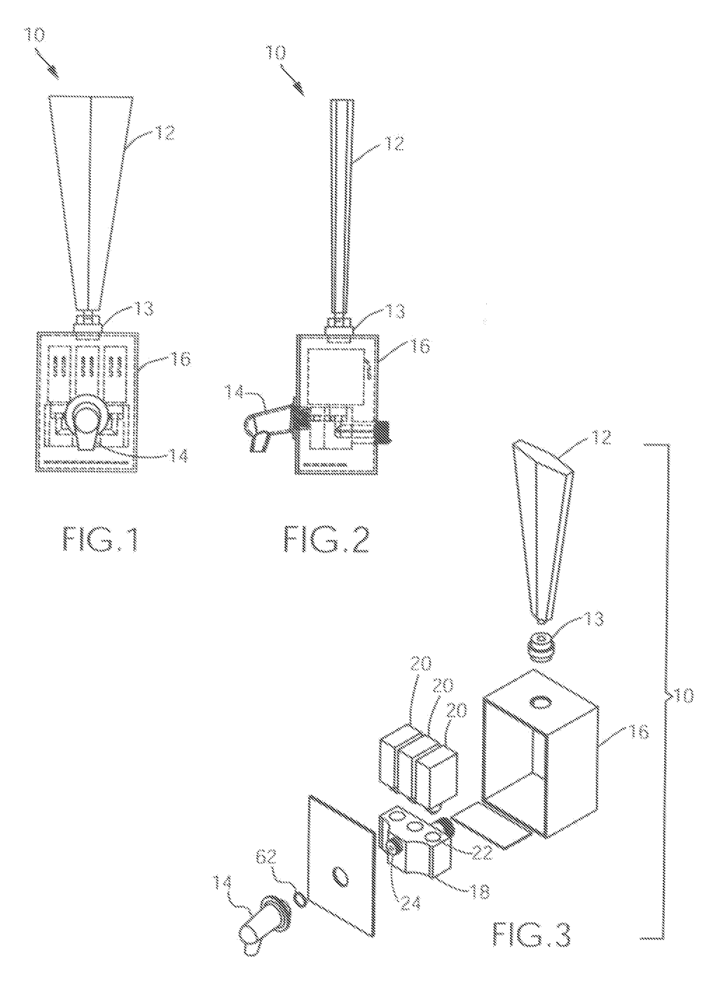

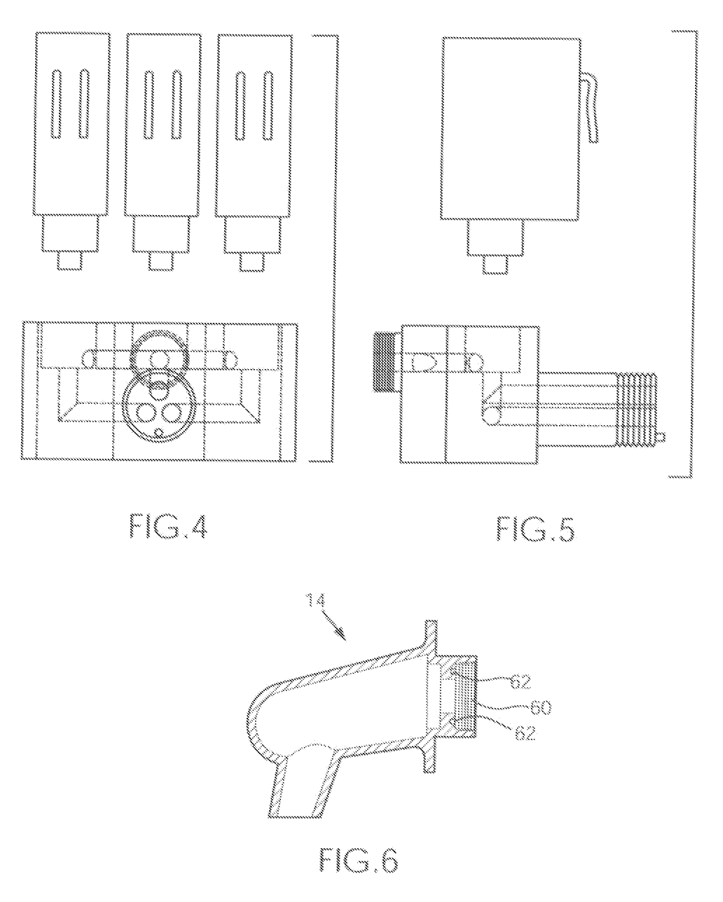

Referring now to FIG. 1-7, a multi-stream draught beer tap 10 is shown according to a preferred embodiment of the present invention. The beer tap 10 comprises a tap handle 12 and a pouring spigot or nozzle 14. Most tap handles are pulled forward to dispense beer and they are replaced back to cease dispensing. The present tap handle 12 operates in a similar manner; however, it can be rotated, twisted, laterally offset or similarly manipulated beforehand to select a draught desired. It is also envisioned that such an actuation mechanism can be functionally replaced with switches or push buttons or other types of electronically actuated controls. In any manner the selection is made because the tap handle 12 manipulates a three-way electronic switch 13 that allows in is functional communication with a series of poppet valves 20 that control the multiple streams of draught beers to be dispensed from one keg handle 12. It would be obvious to a person having ordinary skilled in the relevant art, in light of the present teachings, to use electronically actuated solenoid valves as a functional equivalent for the poppet valves 20. Similarly, it would also be anticipated that any type of switches or push buttons can functionally communicated the operation of the electronic valves direction.

A valve main housing 16 is placed between the tap handle 12 and the nozzle 14 contain the number of electronically actuated poppet valves 20 within. A multi-flow manifold 18 has a series of inlet ports 22, one each in fluid communication with each valve 20 to further communicate to at least three fluid stream tubes (not shown) that travel to respective pressurized keg tanks. As shown in conjunction with FIG. 6, an outlet port 24 communicates directly to the nozzle 14 through a threaded connection 60 sealing an O-ring seal 62 to prevent leakage, dripping or other problems that are known to cause difficulties in fluid communication systems.

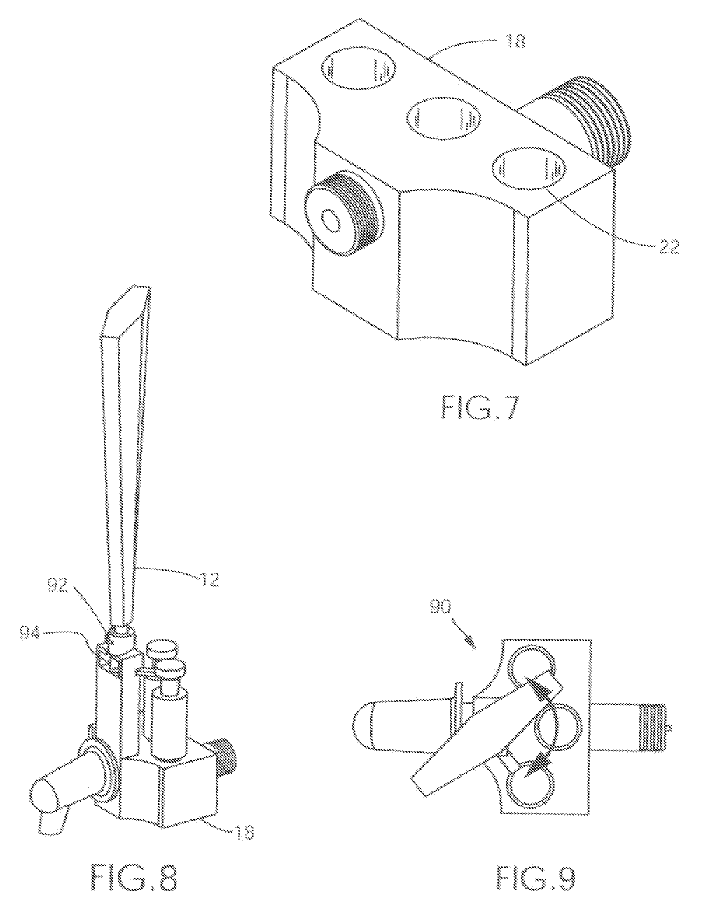

As shown best in conjunction with FIG. 7, each fluid inlet 22 of the manifold 18 has a recessed port 70 for receiving the body of the poppet valve 20. A discharge conduit 72 communicates the fluid stream to the nozzle 14. It has been found that the orientation and geometry of this conduit 72 potentially affects the fluid stream characteristics greatly, depending upon the fluid being transmitted. For a naturally carbonated beverage such as beer, the intended application for the present invention, It has been found that a conduit that is too long and narrow will result in an undesired excess release of gasses from the beer, resulting in excessive undesirable foaming. As such, the conduit 72 needs to be of a sufficient diameter to prevent the occurrence of this effect.

Referring now to FIG. 8-9, a multi stream draught beer tap 90 is shown according to an alternate preferred embodiment of the present invention, in which the electronic poppet valves 20 are replaced by a mechanically actuated poppet valve system 92. This embodiment has the advantage of requiring a smaller form factor for the tap housing 16, but requires a mechanical linkage 94 between the handle 12 and the valve actuator 96.

### 2. Operation of the Preferred Embodiment

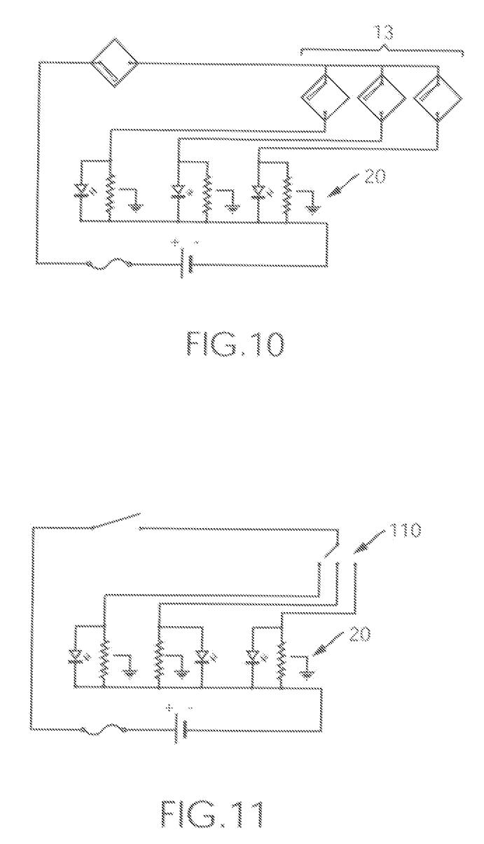

In operation of the preferred embodiment, described in conjunction with FIG. 10, the electronic poppet valves 20 are shown of a spring-to-close design, in which a control signal must be generated in order to open the selected valve 20. The 3-way electronic switch 13 sensing the proximity of the tap handle position in the desired direction, actuates the desired valve 20 to dispense the selected product. Release of the handle 12 will cause the spring (not shown) to reseat the valve 20 to the closed position.

In operation of an alternate embodiment, as shown in FIG. 11, the electronic poppet or electronic solenoid valves 20 are anticipated as being directly controlled by switches 110 of any typically available design, thereby replacing the 3-way electronic proximity sensing switch 13 with more conventional electrical type contact switches.

The foregoing descriptions of specific embodiments of the present invention are presented for purposes of illustration and description only. They are not intended to be exhaustive or to limit the invention to the precise forms disclosed and, obviously, many modifications and variations are possible in light of the above teaching. The embodiments are chosen and described in order to best explain the principles of the invention and its practical application, to thereby enable others skilled in the art to best utilize the invention and the embodiments with various modifications as are suited to the particular use contemplated. It is intended that a scope of the invention be defined by the Claims appended hereto and to their equivalents. Therefore, the scope of the invention is to be limited only by the following claims.

Having thus described the invention what is claimed as new and desired to be secured by Letters Patent is as follows:

1. A multiple stream draught beer dispensing system, comprising:
one tap handle in functional control with at least three control valves;
one spigot;
at least three fluid streams; and
at least three pressurized tanks corresponding with said at least three fluid streams;
wherein said fluid streams are in fluid communication with said spigot through said control valves such that said system allows multiple streams of draught beers to be independently dispersed from said one tap handle.

2. The dispensing system of claim 1, wherein said tap handle can be rotated, twisted, laterally offset or similarly manipulated to select a draught desired.

3. The dispensing system of claim of claim 1, wherein said control valves are selected from the group comprising: electronically controlled poppet valves; manually control poppet valves; and solenoid valves.

4. A multiple stream draught beer tap comprising:
control means for selection of a desired beer;
a multi-flow manifold forming a series of inlet ports, one each in fluid communication with a separate source of beer and further forming a single outlet port;
a nozzle in fluid communication with said outlet port; and
a plurality of valving mechanisms, one each in communication between one each inlet port and said separate source of beer.

5. The multiple stream draught beer tap of claim 4, wherein:
said control means comprises a control tap handle that is in functional communication with an electronic a multi-position electronic switch; and
said valving mechanism are selected from the group comprising: electronic poppet valves; and electronic solenoid valves; wherein said electronic switch is in electrical communication with said valving mechanism for initiating operative controls of a selected valve.

6. The multiple stream draught beer tap of claim 4, wherein:
said control means comprises a plurality of electronic switch; and
said valving mechanism are selected from the group comprising: electronic poppet valves; and electronic solenoid valves;
wherein each said electronic switch is in electrical communication with one said valving mechanism for initiating operative controls of a selected valve.

7. The multiple stream draught beer tap of claim 4, wherein there are three said valving mechanisms and three said sources of beer.

8. The multiple stream draught beer tap of claim 5, wherein there are three said valving mechanisms and three said sources of beer.

9. The multiple stream draught beer tap of claim 6, wherein there are three said valving mechanisms and three said sources of beer.

10. A method of dispensing on of multiple streams of draught beers from one keg handle comprising the steps:
a. providing multiple electronically controlled poppet or solenoid valves, on each in fluid communication with and in communicative control of one said stream of draft beer;
b. communicating an outlet of each said valve with a multiples stream valving manifold in fluid communication with a single nozzle;
c. electronically controlling said multiple electronically controlled poppet or solenoid valves from said single keg handle.
